(19) United States
(12) Patent Application Publication
(10) Pub. No.: US 2007/0168307 A1
(43) Pub. Date: Jul. 19, 2007

(54) System and method for optimally assigning groups of individuals to tasks

(75) Inventors: Christodoulos A. Floudas, Princeton, NJ (US); Stacy L. Janak, Richmond, TX (US); Martin Taylor, Baltimore, MD (US); Maria Burka, Washington, DC (US); T. J. Mountziaris, Williamsville, NY (US)

Correspondence Address: MCCARTER & ENGLISH, LLP, FOUR GATEWAY CENTER, 100 MULBERRY STREET, NEWARK, NJ, 07102, US

(73) Assignee: The Trustees of Princeton University

(21) Appl. No.: 11/520,395

(22) Filed: Sep. 13, 2006

Related U.S. Application Data
(60) Provisional application No. 60/716,547, filed on Sep. 13, 2005.

(51) Int. Cl. G06N 3/12; G06N 3/02

(52) U.S. Cl. 706/19; 706/13

(57) ABSTRACT

A system and method for optimally assigning groups of individuals to tasks, and in particular, a system and method for optimally assigning panels of reviewers to proposals, is disclosed. Information about an assignment problem to be solved acquired, such as the number of available reviewers in each panel, the number of proposals in each panel, reviewer preferences, and optional assignment rules. After data acquisition, a first modeling algorithm having at least one assignment constraint is applied to the acquired data a first modeled assignment scenario. A determination is made as to whether the modeled assignment scenario is feasible. If the modeled assignment is infeasible, a second modeling algorithm is applied to the acquired data to produce a second modeled assignment scenario, wherein one or more constraints to be violated (relaxed) to produce a more feasible outcome. After modeling, the results are displayed to the user and represent a suggested optimal assignment of individuals to tasks.

### RELATED APPLICATIONS

The present application claims the benefit of U.S. Provisional Application Ser. No. 60/716,547 filed Sep. 13, 2005, the entire disclosure of which is expressly incorporated herein by reference.

### BACKGROUND OF THE INVENTION

1. Field of the Invention

The present invention relates to a system and method for optimally assigning groups of individuals to tasks. In particular, the present invention relates to a system and method for optimizing the assignment of panels of reviewers to proposals.

2. Related Art

In many fields, it is very important to assign groups of individuals to tasks, such that individual preferences for specific types of tasks, the efficient expenditure of resources, and other factors, are taken into account during the assignment process. For example, in the academic and scientific fields, it is important that panels of reviewers be properly assigned to proposals submitted to such panels for review. When assigning panels of reviewers to proposals, it is important that various factors be considered, such as the cost of assigning a particular reviewer to a proposal, each reviewer's preferences for reviewing particular types of proposals, and other factors. The optimization of assigning groups of individuals is necessary not only in the academic and scientific fields, but also in other fields, such as personnel management, military planning, healthcare, financial and insurance industries, and other fields.

One example of an assignment problem frequently encountered by a government agency is the National Science Foundation (NSF) panel assignment problem, wherein panels of reviewers must be optimally assigned to proposals submitted to NSF. The NSF panel assignment problem can be viewed as an enhanced version of the generalized assignment problem (GAP), which has been the subject of considerable research over the last twenty years. The GAP has many real-life applications including job scheduling, production planning, modeling of computer and communication networks, storage space allocation, vehicle routing, and facility location problems. The GAP seeks to determine the minimum cost assignment of (n) jobs to (m) agents, such that each job (j) is assigned to exactly one agent (i) subject to resource restrictions on the agents. The GAP can be formulated mathematically as follows:

$${Min }_{x} {\sum }_{i ∈ I} {\sum }_{j ∈ {J}_{i}} {c}_{i , j} {x}_{i , j} \\ \begin{matrix}s . t . {\sum }_{j ∈ {J}_{i}} {a}_{i , j} \cdot {x}_{i , j} \leq {b}_{i} & & ∀ i ∈ I\end{matrix} \\ \begin{matrix}{\sum }_{i ∈ {I}_{j}} {x}_{i , j} = 1 & & ∀ j ∈ J\end{matrix} \\ \begin{matrix}{x}_{i , j} = \{ 0 , 1 \} & & ∀ i ∈ I , & j ∈ {J}_{i}\end{matrix} \qquad Equations 1 –4$$

In Equations 1-4 above, (c_{i,j}) is the cost of assigning job (j) to agent (i), (a_{i,j}) is the amount of resources consumed by job (j) when assigned to agent (i), and (bᵢ) is the resource availability of agent (i). The binary assignment variable (x_{i,j}) equals 1 if agent (i) is to perform job (j), and equals 0 otherwise. Because the GAP is an NP-hard problem, heuristic solutions are often necessary to solve large-scale problems.

A number of algorithms for solving the GAP have, in the past, been developed. Some GAP solution algorithms are based on branch-and-bound techniques and the relaxation of constraints. Other GAP solution algorithms have been proposed that are able to solve problems to optimality which contain up to approximately 200 tasks. These methods differ based on the way the bounds are computed in the branch-and-bound scheme, and different relaxations can be employed including linear relaxations, deletion of constraints, Lagrangian relaxations, surrogate relaxations, and Lagrangian decomposition. A depth-first branch-and-bound algorithm has also been developed to solve the GAP, as well as a Lagrangian relaxation incorporated,within a branch-and-bound formulation. A known refinement of the Lagrangian approach includes a dual ascent procedure and exploits violations of the relaxed constraints. Other approaches include a branch-and-price scheme to solve a set partitioning reformulation of the GAP that incorporates column generation. Yet another approach involves a branch-and-bound algorithm that employs linear programming cuts, feasible-solution generators, Lagrangian relaxation, and subgradient optimization.

Various heuristic methods have also been proposed for the GAP. Examples of such heuristic approaches include a “greedy” heuristic that incorporates local search techniques, an LP relaxation to fix variables and then reassign them using a swap neighborhood, a variable depth search heuristic (VDSH) that is based on two-phase local search descent methods, hybrid, simulated, annealing and tabu search methods using various local search descent techniques, a set partitioning heuristic that utilizes column generation and subgradient optimization (which can be extended to include lift-cover inequalities to improve the lower bound within a branch-and-bound procedure), Lagrangian or surrogate relaxation within a subgradient search procedure and including a variety of heuristics, a hybrid genetic algorithm heuristic extended to include initialization heuristics and a modified handling of infeasible solutions, an improved VDSH which is a generalization of local search and considers several branching rules, and a tabu search algorithm that utilizes ejection chains.

In addition to algorithms and heuristics for solving the GAP, a number of solutions have been developed for solving variations of the GAP. Such variations include the multilevel GAP, where agents perform tasks at more than one efficiency level, the generalized multi-assignment problem (GMAP) which allows multiple assignments for each job, the multi-resource GAP (MRGAP) in which each agent has a number of different potentially constraining resources, a variety of resource-constrained assignment problems where job to agent matching can be one-to-one or one-to-many and resources can be individually or collectively capacitated, and resource-constrained problems for which stochastic implementations are intricate or undesirable.

A particular problem with existing algorithmic and heuristic approaches for solving assignment problems is that such approaches fail to adequately take into account preference-based constraints when calculating assignments, such as individuals' preferences for specific types of tasks or specific roles. Moreover, existing approaches do not flexibly model assignment problems to optimality, such that the feasibility of a modeled outcome for a given problem is presented to the user and the user can re-model the problem using a second model which allows for violations of selected constraints so that a feasible solution can be generated.

Accordingly, what would be desirable, but has not yet been provided, is a system and method for optimally assigning groups of individuals to tasks, which addresses the foregoing limitations of existing approaches to assignment problems.

### SUMMARY OF THE INVENTION

The present invention relates to a system and method for optimally assigning groups of individuals to tasks. In particular, the present invention relates to a system and method for optimally assigning panels of reviewers to proposals. Information about an assignment problem to be solved acquired, such as the number of available reviewers in each panel, the number of proposals in each panel, reviewer preferences (including subject matter preferences for each reviewer and potential conflicts of interest), and optional assignment rules. After data acquisition, a first modeling algorithm having at least one assignment constraint is applied to the acquired data a first modeled assignment scenario. A determination is made as to whether the modeled assignment scenario is feasible. If the modeled assignment is infeasible, a second modeling algorithm is applied to the acquired data to produce a second modeled assignment scenario, wherein one or more constraints to be violated (relaxed) to produce a more feasible outcome. After modeling, the results are displayed to the user and represent a suggested optimal assignment of individuals to tasks. The present invention could be implemented using a customized, web-based application accessible over the Internet. Further, the present invention could be applied to solve assignment problems in numerous scenarios, such as hotel/hospitality resource assignment problems, military personnel and equipment assignment problems, human resources scheduling problems, etc.

### BRIEF DESCRIPTION OF THE DRAWINGS

Other important objects and features of the present invention will be apparent from the following Detailed Description of the Invention, taken in connection with the accompanying drawings, in which:

FIG. 1 is a flowchart showing the method of the present invention for optimizing the assignment of groups of individuals to tasks;

FIG. 2 is a flowchart showing the modeling step 22 of FIG. 1 in greater detail;

FIG. 3 is a table showing a preference criteria matrix corresponding to a first panel assignment problem solved by the present invention;

FIG. 4 is a table showing an optimal assignment solution generated by the present invention for the first panel assignment problem;

FIG. 5 is a table showing an assignment solution to the first panel assignment problem, generated manually.

FIGS. 6A-6D are tables showing four additional, rank-ordered integer solutions to the first panel assignment problem, solved by the present invention;

FIG. 7 is a table showing a preference criteria matrix corresponding to a second panel assignment problem solved by the present invention;

FIG. 8 is a table showing an optimal assignment solution generated by the present invention for the second assignment problem;

FIG. 9 is a table showing modeling and solution statistics for optimal assignment solutions generated by the present invention for a third assignment problem;

FIG. 10 is a table showing modeling and solution statistics for optimal assignment solutions generated by the present invention or a fourth assignment problem;

FIG. 11 is a diagram showing hardware and software components, as well as processing logic, for implementing the present invention as a web-based application accessible via the Internet;

FIGS. 12A-12H are screenshots showing a sample user interface according to the present invention for allowing users to solve panel assignment problems online; and

FIG. 12I shows a sample optimal solution generated by the present invention and e-mailed to a user by the user interface shown in FIGS. 12A-12H.

### DETAILED DESCRIPTION OF THE INVENTION

The present invention relates to a system and method for optimally assigning groups of individuals to tasks, and in particular, to a system and method for optimally assigning panels of reviewers to proposals. Information about an assignment problem to be solved acquired, such as the number of available reviewers in each panel, the number of proposals in each panel, reviewer preferences, and optional assignment rules. After data acquisition, a first modeling algorithm having at least one assignment constraint is applied to the acquired data a first modeled assignment scenario. A determination is made as to whether the modeled assignment scenario is feasible. If the modeled assignment is infeasible, a second modeling algorithm is applied to the acquired data to produce a second modeled assignment scenario, wherein one or more constraints to be violated (relaxed) to produce a more feasible outcome. After modeling, the results are displayed to the user and represent a suggested optimal assignment of individuals to tasks. As used herein, the terms “optimal,” “optimization,” and “optimality” refer to the generation of a solution to an assignment problem wherein minimal costs are incurred while violations of assignment constraints and/or rules are minimized.

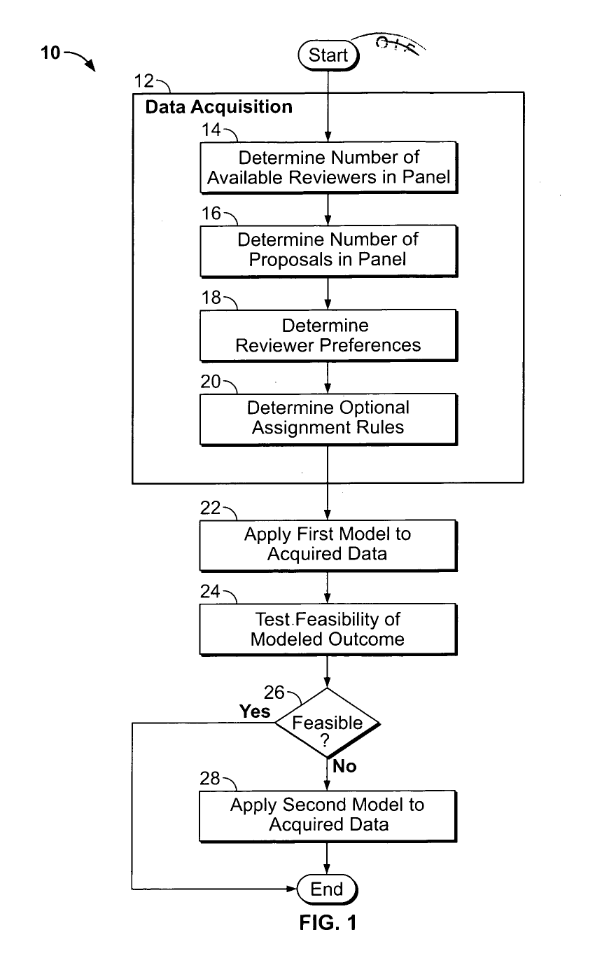

FIG. 1 is a flowchart showing the method according to the present invention, indicated generally at 10, for optimally assigning groups of individuals to tasks. In particular, the method 10 allows a user to optimally assigning panels of reviewers to proposals. As mentioned earlier, the present invention can be applied to solve panel assignment problems which relate to the assignment of panels of reviewers to proposals, including the National Science Foundation (NSF) panel assignment problem. The method 10 can be implemented to solve not only the NSF panel assignment problem, but also a variety of panel assignment problems including the generalized assignment problem (GAP) to optimality. Further, the method 10 could be applied to solve a number of assignment problems in number of applications, such as to solve hotel/hospitality resource assignment problems, military personnel and equipment assignment problems, human resources scheduling problems, etc.

The NSF panel assignment problem can be defined as follows. Given (i) the number of available reviewers; (ii) the number of proposals in the panel; (iii) the number of reviews needed for each proposal; and (iv) a matrix of preferences for each reviewer on each proposal, the objective is to determine an assignment of reviewers to proposals on the panel so as to optimize the sum of the preferences for the reviewers to their assigned proposals. In addition, there are several requirements that must be met, as follows:
(1) each reviewer should be assigned to approximately the same number of proposals;
(2) each proposal should be assigned to the same number of reviewers;
(3) reviewers that have a “conflict of interest” (COI) with a proposal must not be assigned to that proposal;
(4) each proposal should have three or four distinct positions (LEAD, SCRIBE, REV1, REV2) and each position must be filled exactly once for each proposal and each reviewer should be assigned to each position approximately the same number of times; and
(5) the assignment of reviewers to positions should follow the priority w^{LEAD}_{i,j}≦w^{SCRIBE}_{i,j}≦w^{R1}_{i,j}≦w^{R2}_{i,j} according to the preferences of the reviewers (j) for the proposals (i). Note that the smaller the value of w_{i,j}>0, the higher the preference of a reviewer for a proposal. Typical values for w_{i,j} are integers ranging from 1 for the highest preference to N for the lowest preference where N is the total number of proposals in the panel.

Beginning in step 12, data regarding a particular assignment problem is gathered. In data acquisition step 14, the number of available reviewers in a panel is determined. Then, in data acquisition step 16, the number of proposals in a panel is determined. In step 18, reviewer preferences are determined. Finally, in step 20, any applicable optional assignment rules are determined. After data regarding a particular problem has been acquired, step 22 occurs, wherein the acquired data is modeled using a first assignment modeling algorithm. After. modeling, step 24 occurs, wherein the feasibility of the modeled outcome is tested by presenting the modeled outcome to the user. In step 26, a decision is made by the user as to whether the modeled outcome is feasible. If so, modeling is complete, and the user can implement the modeled outcome. If a negative determination is made, step 28 is invoked, wherein the acquired data is modeled using a second assignment modeling algorithm. The second assignment modeling algorithm is similar to the first assignment modeling algorithm, except that selected assignment constraints specified by the user are relaxed. After modeling, the second modeled outcome is presented to the user. Re-modeling can be repeated as many times as desired by the user.

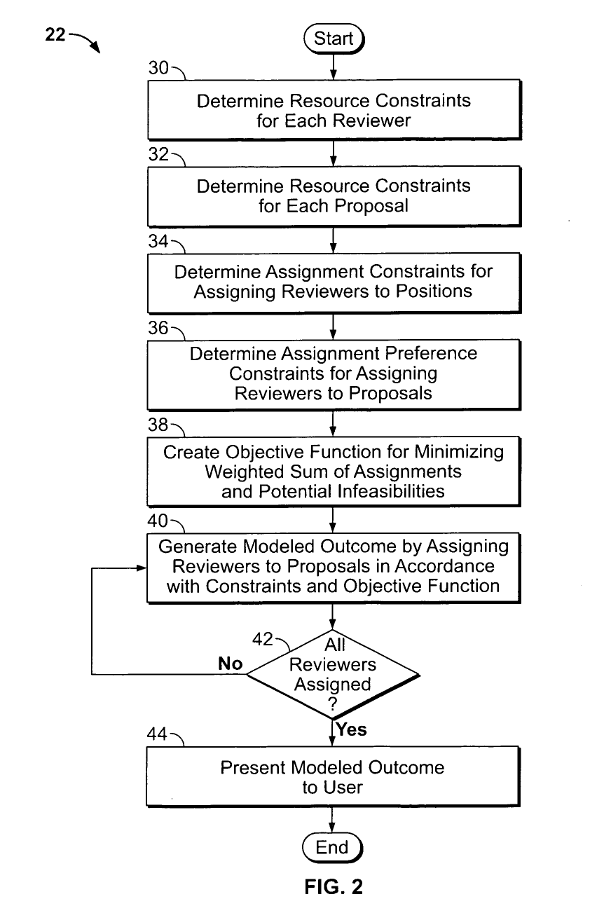

FIG. 2 is a flowchart showing processing step 22 of FIG. 1 in greater detail. In processing step 22, the acquired data is modeled using a first modeling algorithm in accordance with the present invention. The first modeling algorithm includes the following indices, sets, parameters, and variables:

Indices and Sets
i∈I proposals in the panel;
j∈J reviewers in the panel;
j∈Jᵢ reviewers (j) which can be assigned to proposal (i), (i.e., preference w_{i,j}>0); and
i∈Iⱼ proposals (i) which can be assigned to reviewer (j), (i.e., preference w_{i,j}>0).

Parameters
N total number of proposals (i), (i.e., cardinality of the set I);
M total number of reviewers (j), (i.e., cardinality of the set J);
K number of reviews needed for each proposal (i), (e.g., 3 or 4);
w_{i,j} preference of each reviewer (j) for each proposal (i); and
ε a small positive constant, (e.g., 0.001).

Variables
y(i,j) binary, whether or not reviewer (j) is assigned to proposal (i);
L(i,j) binary, whether or not reviewer (j) is the LEAD for proposal (i);
S(i,j) binary, whether or not reviewer (j) is the SCRIBE for proposal (i);
R1(i,j) binary, whether or not reviewer (j) is the REV1 for proposal (i);
R2(i,j) binary, whether or not reviewer (j) is the REV2 for proposal (i);
x(i,j,jj) binary, whether or not reviewer (j) has an equal or higher preference for proposal (i) as reviewer (jj), (i.e., w_{i,j}<w_{i,jj}); and
sl(i,j,jj) continuous, slack variable to relax the condition that reviewer (j) has as equal or higher preference for proposal (i) as reviewer (jj).

On the basis of the foregoing notations, the first modeling algorithm of the present invention begins in step 30, wherein resource constraints for each reviewer in the panel are determined. Such constraints can be expressed mathematically in Equation 5, below:

$$\begin{matrix}⌊ \frac{N \cdot K}{M} ⌋ \leq {\sum }_{i ∈ {I}_{j}} y ( i , j ) \leq ⌈ \frac{N \cdot K}{M} ⌉ , & ∀ j ∈ J\end{matrix} \qquad Equation 5$$

Specifically, these constraints express the requirement that each reviewer (a) must be assigned to a at least └[(N·K)/M]┘ proposals (i) and at most └[(N·K)/M]┘ proposals (i) where ┌ ┐ indicates the floor function and ┌ ┐ indicates the ceiling function. This ensures that each reviewer is assigned to approximately the same number of proposals. Additional resource constraints are also defined, and are expressed mathematically in Equations 6-9, below.

$$\begin{matrix}\begin{matrix}⌊ \frac{N}{M} ⌋ \leq {\sum }_{i ∈ {I}_{j}} L ( i , j ) \leq ⌈ \frac{N}{M} ⌉ , & ∀ j ∈ J\end{matrix} & Equation 6 \\ \begin{matrix}⌊ \frac{N}{M} ⌋ \leq {\sum }_{i ∈ {I}_{j}} S ( i , j ) \leq ⌈ \frac{N}{M} ⌉ , & ∀ j ∈ J\end{matrix} & Equation 7 \\ \begin{matrix}⌊ \frac{N}{M} ⌋ \leq {\sum }_{i ∈ {I}_{j}} R 1 ( i , j ) \leq ⌈ \frac{N}{M} ⌉ , & ∀ j ∈ J\end{matrix} & Equation 8 \\ \begin{matrix}⌊ \frac{N}{M} ⌋ \leq {\sum }_{i ∈ {I}_{j}} R 2 ( i , j ) \leq ⌈ \frac{N}{M} ⌉ , & ∀ j ∈ J , & K = 4\end{matrix} & Equation 9\end{matrix}$$

The forgoing constraints enforce the rule that each reviewer (j) must be assigned to each position (i.e., LEAD, SCRIBE, REV1, REV2) at least └[N/M]┘ times and at most ┌[N/M]┐ times. This ensures that each reviewer holds each position approximately the same number of times.

In step 32, resource constraints for each proposal are then determined. Such constraints can be expressed mathematically in Equation 10, below:

$$\begin{matrix}{\sum }_{j ∈ {J}_{i}} y ( i , j ) = K , & ∀ i ∈ I\end{matrix} \qquad Equation 10$$

The constraints determined in step 32 express the requirement that each proposal (i) must be reviewed by exactly K reviewers, or y(i,j)=1 exactly K times. Additional constraints are defined in Equations 11-14, below.

$$\begin{matrix}\begin{matrix}{\sum }_{j ∈ {J}_{i}} L ( i , j ) = 1 , & ∀ i ∈ I\end{matrix} & Equation 11 \\ \begin{matrix}{\sum }_{j ∈ {J}_{i}} S ( i , j ) = 1 , & ∀ i ∈ I\end{matrix} & Equation 12 \\ \begin{matrix}{\sum }_{j ∈ {J}_{i}} R 1 ( i , j ) = 1 , & ∀ i ∈ I\end{matrix} & Equation 13 \\ \begin{matrix}{\sum }_{j ∈ {J}_{i}} R 2 ( i , j ) = 1 , & ∀ i ∈ I , & K = 4\end{matrix} & Equation 14\end{matrix}$$

The constraints represented above in Equations 11-14 enforce the rule that for each proposal (i), all of the positions must be filled exactly once. Thus, one reviewer is assigned to be the LEAD (i.e., L(i,j)=1), one reviewer is assigned to be the SCRIBE (i.e., S(i,j)=1), one reviewer is assigned to be REV1 (i.e., R1(i,j)=1), and if K=4, then one reviewer is assigned to be REV2 (i.e., R2(i,j)=1).

In step 34, assignment constraints for assigning reviewers to positions on a panel are determined. Mathematically, these constraints can be expressed as shown in Equation 15, below:
L(i,j)+S(i,j)+R1(i,j)+R2(i,j)=y(i,j), ∀i∈I, j∈Jᵢ Equation 15
These constraints represent the requirement that if a reviewer (j) is assigned to a proposal (i) (i.e., y(i,j)=1), then that reviewer must be assigned to exactly one of the four positions. Additional assignment constraints are also defined, as represented by Equations 16-19, below.
L(i,j)≦y(i,j), ∀i∈I, j∈Jᵢ Equation 16
S(i,j)≦y(i,j), ∀i∈I, j∈Jᵢ Equation 17
R1(i,j)≦y(i,j), ∀i∈I, j∈Jᵢ Equation 18
R2(i,j)≦y(i,j), ∀i∈I, j∈Jᵢ, K=4 Equation 19
The constraints shown above in Equations 16-19 enforce the rule that a reviewer (j) can only be assigned to a specific position on a proposal (i) if the reviewer is actually assigned to the proposal (i.e., y(i,j)=1).

In step 36, preference constraints for assigning reviewers to proposals are determined. Specifically, the following preference constraints set forth in Equation 20 were developed to assign reviewers to proposals using the preference criteria matrix, w_{i,j}, and are based on logic inference principles.
L(i,j)+S(i,jj)−x(i,j,jj)≦1, ∀i∈I, j,jj∈Jᵢ, j≠jj Equation 20
These constraints represent the requirement that if reviewer (j) has a lower preference for proposal (i) than reviewer (jj) (i.e., x(i,j,jj)=0), then if reviewer (j) is assigned to the proposal as LEAD, then reviewer (jj) cannot be assigned to the proposal as SCRIBE. Similarly, if reviewer (jj) is assigned to the proposal as SCRIBE, then reviewer (j) cannot assigned to the proposal as LEAD. Further constraints set forth in Equations 21-24, below, are also defined:
S(i,j)+R1(i,jj)−x(i,j,jj)≦1, ∀i∈I, j,jj∈Jᵢ, j≠jj Equation 21

The constraints set forth in Equation 21 represent the requirement that if reviewer (j) has a lower preference for proposal (i) than reviewer (jj) (i.e., x(i,j,jj)=0, then if reviewer (j) is assigned to the proposal as SCRIBE, then reviewer (jj) cannot be assigned to the proposal as REV1. Similarly, if reviewer (jj) is assigned to the proposal as REV1, then reviewer (j) cannot be assigned to the proposal as SCRIBE.
R1(i,j)+R2(i,jj)−x(i,j,jj)≦1, ∀i∈I, j,jj∈Jᵢ, j≠jj, K=4 Equation 22

Similar to the constraints defined in Equations 20 and 21, the constraints set forth in Equation 22 represent the requirement that if reviewer (j) has a lower preference for proposal (i) than reviewer (jj) (i.e., x(i,j,jj)=0, then if reviewer (j) is assigned to the proposal as REV1, then reviewer (jj) cannot be assigned to the proposal as REV2. Or, if reviewer (jj) is assigned to the proposal as REV1, then reviewer (j) cannot be assigned to the proposal as SCRIBE.
−N·(1−x(i,j,jj))≦w_{i,jj}−w_{i,j}+sl(i,j,jj), ∀i∈I, j,jj∈Jᵢ, j≠jj Equation 23
w_{i,jj}−w_{i,j}+sl(i,j,jj)≦N·x(i,j,jj)−ε, ∀i∈I, j,jj∈Jᵢ, j≠jj Equation 24
The constraints set forth in Equations 23 and 24 relate the value of x(i,j,jj) to the relative values of the preference criteria w_{i,j} and w_{i,jj} so that if w_{i,j}≦w_{i,jj}, then x(i,j,jj)=1. Similarly, if w_{i,j}>w_{i,jj}, then x(i,j,jj)=0. However, if no feasible solution is available where the preference constraints for each reviewer are maintained for each proposal, then the slack variable, sl(i,j,jj) is activated allowing w_{i,j}>w_{i,jj} and x(i,j,jj)=1 where sl(i,j,jj)=|w_{i,jj}−w_{i,j}|. This slack variable then penalized in the objective to avoid finding solutions which violate the preference constraints.

In step 38, an objective function is created for minimizing the weighted sum of assignments and potential infeasibilities in the modeled outcome. The objective function can be defined as shown in Equation 25, below.

$$Min {\sum }_{i ∈ I} {\sum }_{j ∈ {J}_{i}} {w}_{i , j} \cdot y ( I , j ) + α \cdot {\sum }_{i ∈ I} {\sum }_{j ∈ {J}_{i}} {\sum }_{jj ∈ {J}_{i} , j \neq jj} sl ( i , j , jj ) \qquad Equation 25$$

The objective function shown in Equation 25 represents the minimization of the weighted sum of assignments of reviewers to proposals, plus a term to minimize the infeasibilities introduced through the assignment of reviewers to positions. Thus, the objective function seeks to select an assignment of reviewers (j) to proposals (i) so that the sum of all the preference criteria, w_{i,j}, for the chosen assignments (i.e., y(i,j)=1) is minimized and the preference constraints for reviewers to proposals are violated only if necessary. In this case, the second term in the objective ensures that the preference constraints are violated by the smallest amount possible. Note that a balances the relative weight of both terms in the objective and is chosen to be large enough so that violations of the preference constraints are avoided if possible. Thus, the value of α is dependent on the relative value of the first term in the objective function. α should be chosen so that the second or penalty term in the objective, if it is active, will be at least one order of magnitude larger than the first term.

In step 40, after all constraints have been defined and the objective function created, a modeled outcome is determined by assigning reviewers to proposals in accordance with the constraints and the objective function. In step 42, a determination is made as to whether all reviewers have been assigned. If a negative determination is made, step 40 is repeated as needed. If a positive determination is made, modeling is complete, and step 44 is invoked, wherein the modeled outcome is presented to the user.

The Equations 5-25 above represent integer linear optimization equations which can be solved to optimality using any suitable, commercially-available linear solver. Additionally, a rank-ordered list of optimal solutions can be generated by introducing integer cuts and resolving the model.

The foregoing first modeling algorithm (“Model 1”) shown in FIG. 2 and described above is identical to the second modeling algorithm (“Model 2”) implemented in step 28 of FIG. 1, except that the values of the slack variables sl(i,j,jj) in the second modeling algorithm are adjusted as necessary to compensate for infeasibilities that may result from the first modeling algorithm. Note that Equations 23, 24, and 25 above all contain the positive slack variables sl(i,j,jj), which allow for the introduction of violations in the assignment of reviewers to specific positions (i.e., LEAD, SCRIBE, REV1, or REV2) for a proposal (i). Because the addition of the slack variables increases the size of the mathematical model, the problem is first solved using the first modeling algorithm without the slack variables and then, if necessary, the slack variables are introduced in the second modeling algorithm. Specifically, Model 1 is formulated so that all the slack variables are fixed to zero in Equations 23, 24, and 25, enforcing that no violations are allowed in the optimal solution. Thus, the objective function only involves one term to minimize the weighted sum of the assignment of reviewers to proposals. Model 2 is then formulated using the above equations and objective function as defined, including the positive slack variables. Note that Model 1 and Model 2 contain the same number of constraints; however, Model 2 contains an additional set of continuous variables, making the problem a mixed-integer linear programming problem instead of an integer programming problem.

In Models 1 and 2, the preference criteria matrix w_{i,j} represents the preference of each reviewer ((j) for each proposal (i), where the smaller the value of w_{i,j}>0, the larger the preference for the proposal. If there is a conflict of interest (COI) for a reviewer on a specific proposal, then w_{i,j} should be set to zero. In turn, the condition that w_{i,j}=0 ensures that the sets Iⱼ and Jᵢ are empty for that combination of reviewer (j) and proposal (i), thus y(i,j) never appears in any of the constraints in the model and consequently takes on a value of zero. Similarly, equivalent constraints to enforce this condition can be expressed as set forth below in Equation 26.
y(i,j)=0, ∀i∈I, j∉Jᵢ Equation 26
In addition, for the cases when a reviewer (j) does not give a preference for a proposal (i), or w_{i,j} is left blank, w_{i,j} can be assigned a large value or the worst-case value of N, which represents the total number of proposals. Also, note that each proposal (i) must have at least K nonzero entries in the preference criteria matrix, w_{i,j} (i.e., at least K reviewers who do not have a conflict of interest), where K is the number of reviews needed per proposal. Otherwise, there are not enough available reviewers for proposal (i) and the problem will not have a feasible solution.

It has been found that the present invention can be implemented to solve the panel assignment problem to optimality. The present invention has been tested for the cases when there are either three or four reviews required for each proposal. Note that the models can be extended to the general case in which the number of reviews is proposal specific, or Kᵢ. However, the current formulation addresses the case when K=3 or K=4. For the case when K=3, the following constraint is included in the model:
R2(i,j)=0, ∀i∈I, j∈J Equation 27
This constraint ensures that no reviewers (j) are assigned to the position REV2. Similarly, the constraints set forth in Equations 9, 14, 19, and 22 above are not included in the mathematical model when K=3.

It should be mentioned that since the assignment constraints for assigning reviewers to positions (i.e., in Equation 15 above), correspond to the definitions of the y(i,j) variables, this expression can be substituted into the appropriate constraints and hence eliminate the y(i,j) variables along with some sets of constraints. This results in a more compact model with fewer binary variables and constraints. Thus, the constraints expressed in Equations 5, 10, and 25 can be redefined without the y(i,j) variables, as shown in Equations 27-29 below.

$$⌊ \frac{N \cdot K}{M} ⌋ \leq {\sum }_{i ∈ {I}_{j}} ( L ( i , j ) + S ( i , j ) + R 1 ( i , j ) + R 2 ( i , j ) ) \leq ⌈ \frac{N \cdot K}{M} ⌉ , ∀ j ∈ J \\ \begin{matrix}{\sum }_{j ∈ {J}_{i}} ( L ( i , j ) + S ( i , j ) + R 1 ( I , j ) + R 2 ( i , j ) ) = K , & ∀ i ∈ I\end{matrix} \\ Min {\sum }_{i ∈ I} {\sum }_{j ∈ {J}_{i}} {w}_{i , j} \cdot ( L ( i , j ) + S ( i , j ) + R 1 ( i , j ) + R 2 ( i , j ) ) + α \cdot {\sum }_{i ∈ I} {\sum }_{j ∈ {J}_{i}} {\sum }_{jj ∈ {J}_{i} , j \neq jj} sl ( i , j , jj ) \qquad Equations 27 –29$$

Also, the constraints expressed in Equations 16-19 can be removed from the model, and the constraints of Equation 15 need to be rewritten in order to ensure that no reviewer (j) is assigned to more than one position for a single proposal (i), as shown in Equation 30 below:
L(i,j)+S(i,j)+R1(i,j)+R2(i,j)≦1, ∀i∈I, j∈Jᵢ Equation 30
Using this form of the model, (I·Jᵢ) binary variables and (4·I·Jᵢ) constraints are removed. In the examples that follow, this model is referred to as the reformulated version of the model.

### EXAMPLES

In the examples summarized below, several panel assignment problems were solved to demonstrate the effectiveness of the present invention. Each example was implemented using the General Algebraic Modeling System (GAMS) version 2.50 software on a 3.20 GHz Linux, workstation, and solved with the CPLEX linear solver software version 9.0.

### Example 1

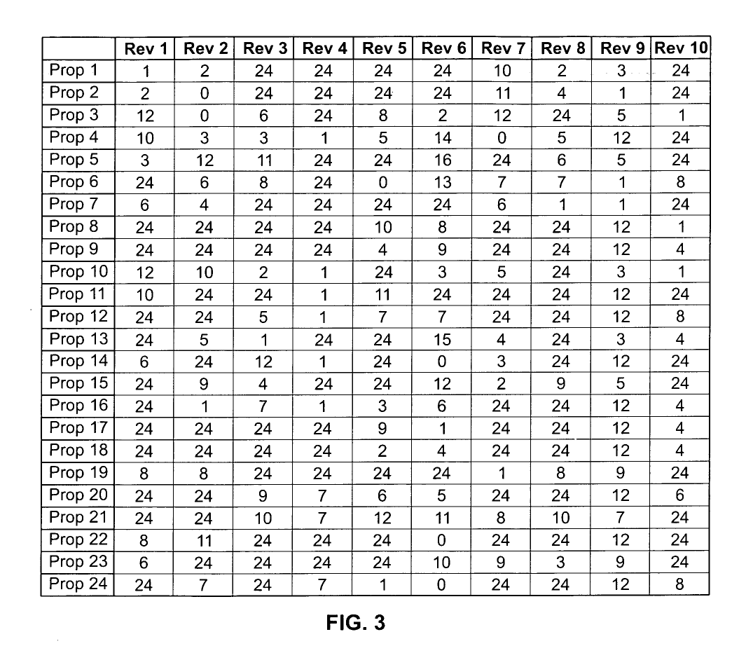

The present invention was tested using a simple panel assignment problem involving 10 reviewers to be assigned to 24 proposals so that each proposal is reviewed exactly 3 times. Thus, N=24, M=10, and K=3. The preference criteria matrix for each reviewer on each proposal is shown in FIG. 3. The values for the preference criteria matrix could be expressed as integers on an ascending preference scale from 1 to n, where n could represent the highest proposal number. Such values could be repeated as desired by the user. Any other suitable scale and associated values could be implemented (e.g., values 1 through 10) without departing from the spirit or scope of the present invention.

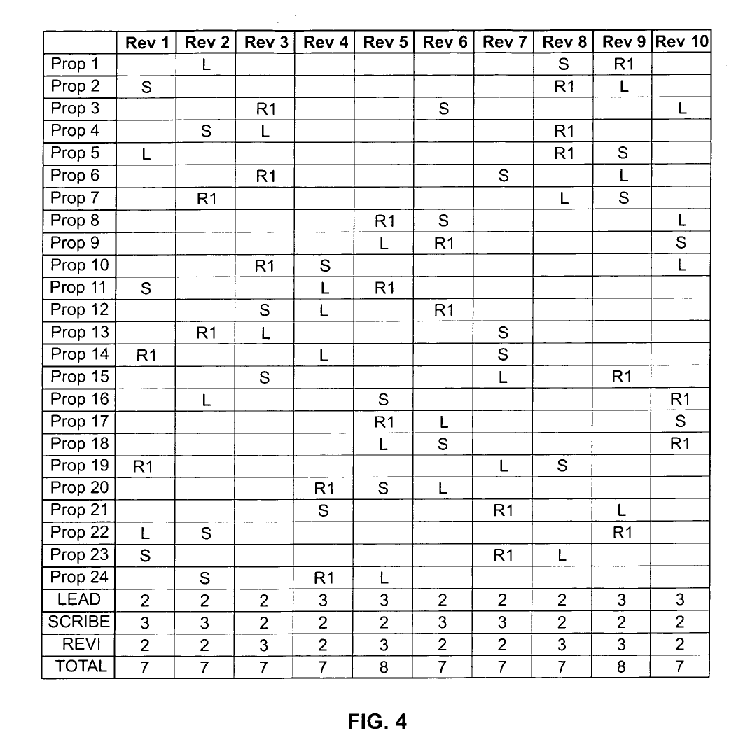

The optimal solution has an objective function value of 329, and the assignments generated by the present invention are shown in FIG. 4. Note that each reviewer is assigned to 7 or 8 proposals, and is assigned to be the LEAD (L), the SCRIBE (S), and the REV1 (R1) either 2 or 3 times each. In addition, although the problem involves a large number of binary variables (2,165 for the original model and 1,932 for the reformulated model), it is solved to optimality at the root node in a fraction of a second.

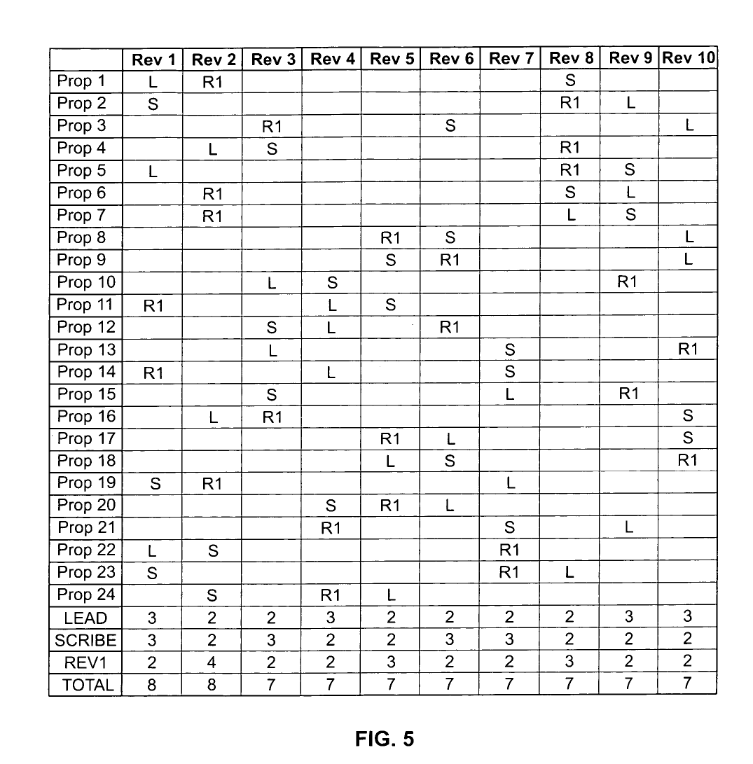

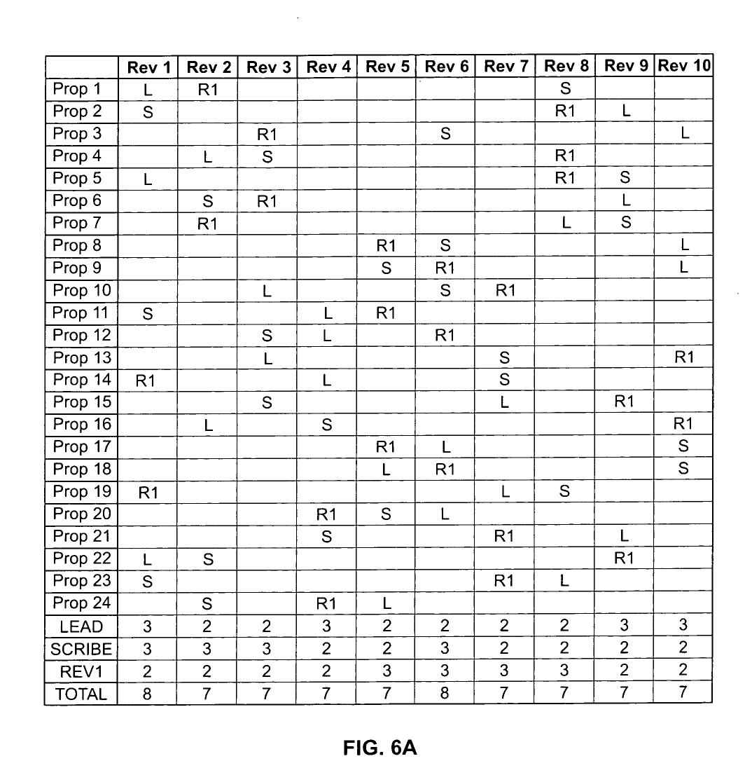

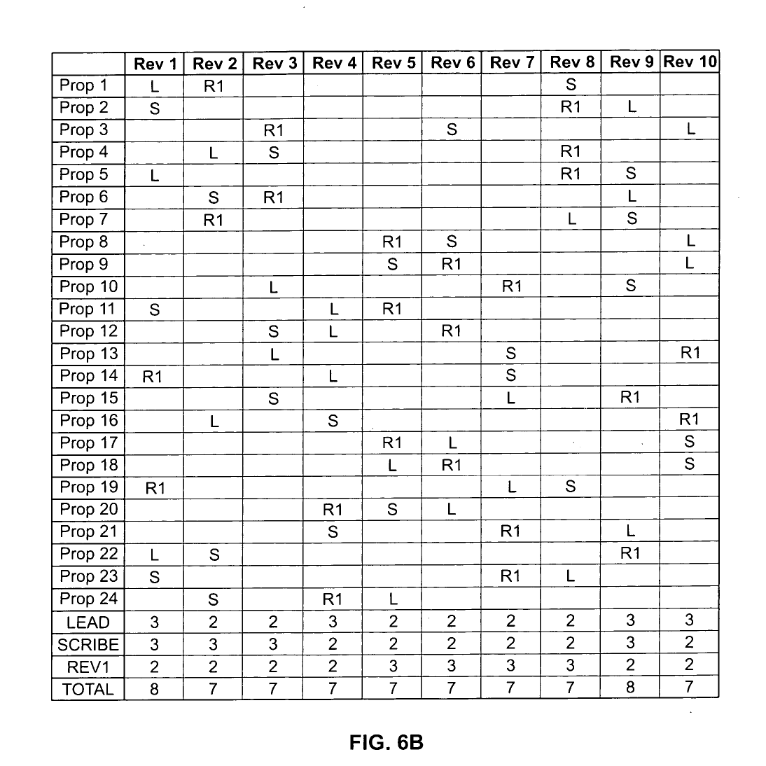

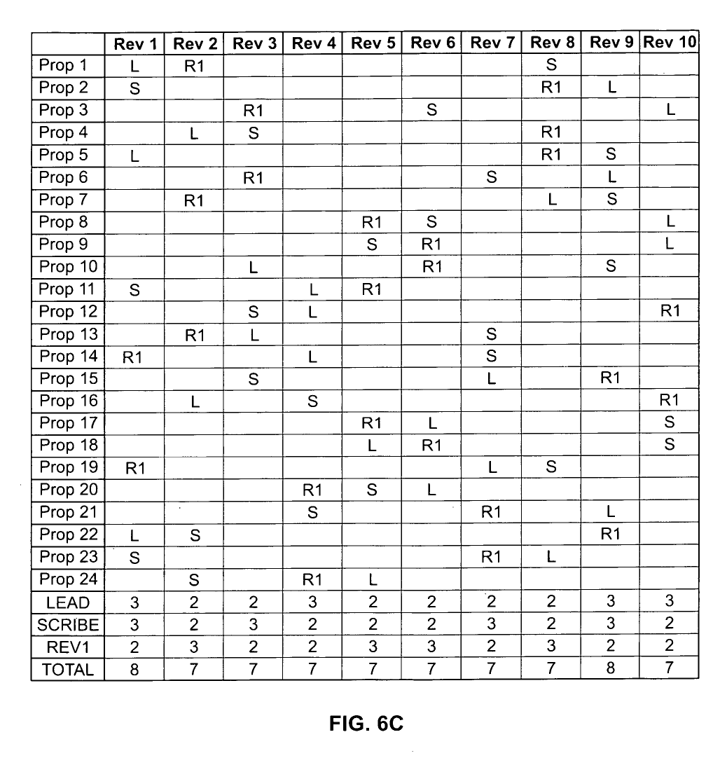

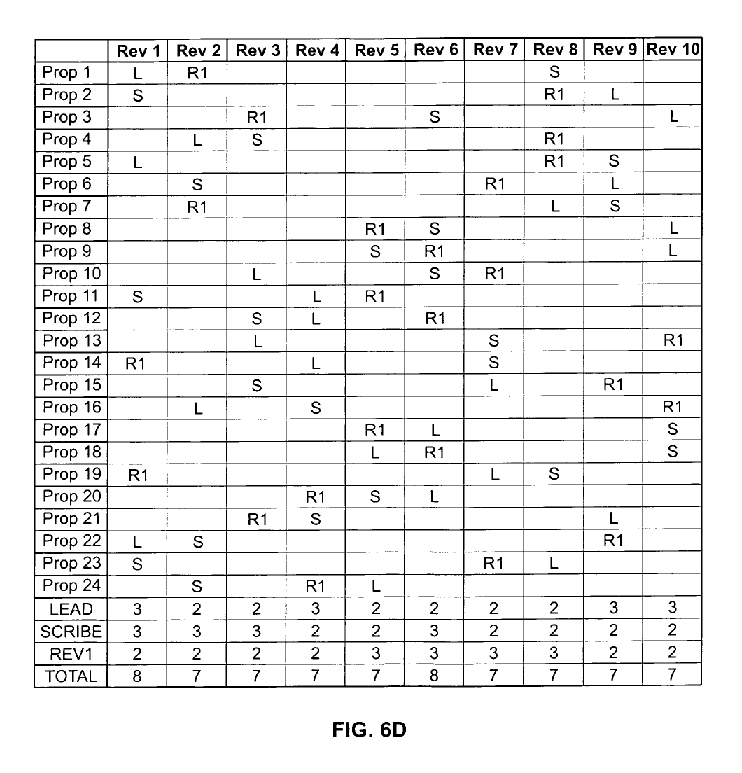

A manual solution was also previously determined for this example problem by the NSF, allowing a direct comparison with the proposed mathematical approach. The manual solution corresponds to an objective function value of 342 and the assignment of reviewers to proposals can be seen in FIG. 5. The manual solution was generated through trial and error, and serves, as a useful basis for comparing the solutions generated by the present invention to human-generated solutions. Note that the manual solution violates several of the constraints in the proposed formulation. First, reviewer 2 is assigned to 4 proposals as REV1. Also, proposals 6, 11, 20, and 21 assign the position REV1 to a reviewer who has a higher preference (or lower w_{i,j}) for the proposal than the reviewer assigned to the position SCRIBE. In addition, proposal 10 assigns the position SCRIBE to a reviewer who has a higher preference for the proposal than the reviewer assigned to the position LEAD. Thus, the proposed mathematical model is able to determine an assignment of reviewers to proposals with an optimal objective function value and satisfies all the required conditions. In contrast, the manual solution as an inferior objective function value and does not meet all the necessary requirements. FIGS. 6A-6D are tables showing four additional, rank-ordered integer solutions to the problem described above for Example 1, with objective function values of 329 (FIGS. 6A-6B) and 330 (FIGS. 6C-6D).

### Example 2

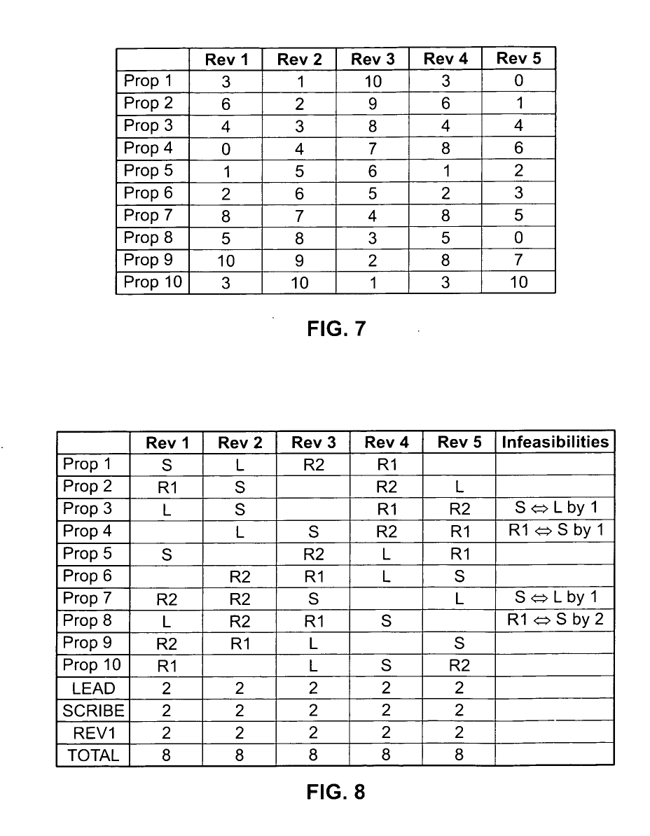

The present invention was tested using an instance of the panel assignment problem which cannot satisfy the preference constraints for reviewers to proposals and thus must introduce infeasibilities (i.e., sl(i,j,jj)) into the solution. Thus, if the slack variables are not included, then the problem is infeasible. This example involves 5 reviewers that must be assigned to 10 proposals so that each proposal is reviewed exactly 4 times. Thus, N=10, M=5, and K=4. The preference criteria matrix for each reviewer on each proposal is shown in FIG.7.

The optimal solution using α=1000 has an objective function value of 5188 where the first term in the objective has a value of 188. The assignments and infeasibilities are shown in FIG. 8. Note that each reviewer is assigned to 8 proposals and is assigned to be the LEAD (L), the SCRIBE (S), the REV1 (R1), and the REV2 (R2) exactly 2 times each. However, these assignments are made by introducing infeasibilities into the preference constraints for reviewers to proposals. For instance, for proposal 3, reviewer 1 is assigned to be the LEAD and reviewer 2 is assigned to be the SCRIBE. However, reviewer 2 has a preference of 3 for proposal 3 and reviewer 1 has a preference of 4. Thus, the assignment of positions does not follow the preference constraints for reviewers to proposals. This assignment, though, corresponds to the minimum violation of the preference constraints for reviewers to proposals. Note that there are additional integer solutions with an objective function value of 188, each which corresponds to a different set of violations of the preference constraints.

### Example 3

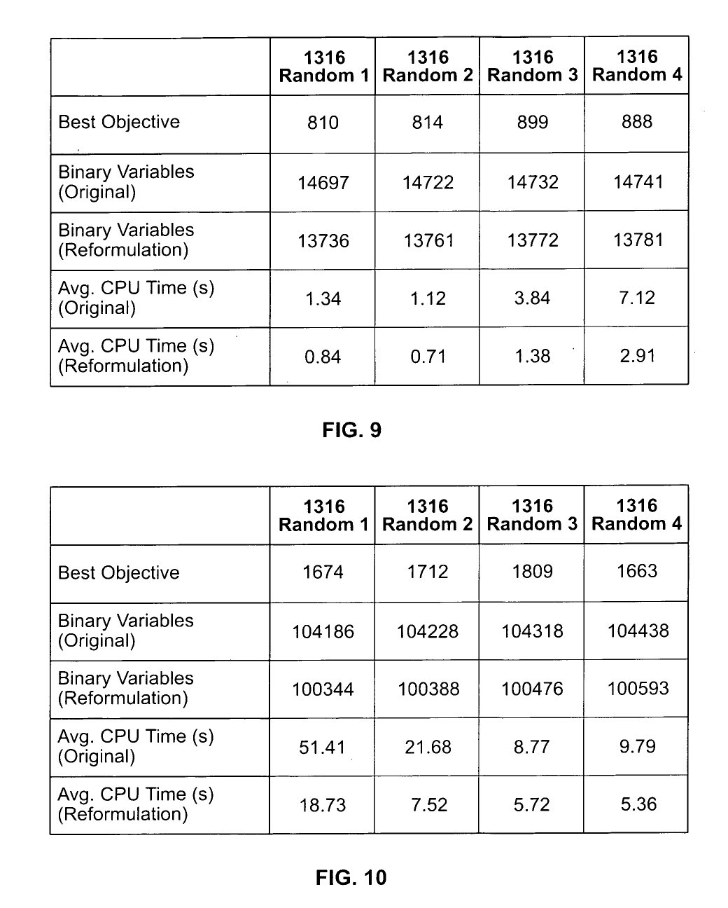

The present invention was tested using a larger panel assignment problem which involves 20 reviewers that must be assigned to 50 proposals, such that each proposal is reviewed exactly 3 times. Thus, N=50, M=20, and K=3. The preference criteria matrix for each reviewer on each proposal is generated randomly so that each reviewer has 2 conflicts of interest and gives preferences for 25 proposals from 1 to 25. Then, the other 23 proposals are given a worst-case value of 50. Four different, randomly-generated preference criteria were considered, and each was solved with both the original model and the reformulated model to produce ten integer solutions. The model and solution statistics for this example are shown in FIG. 9. The optimal objective function varies between each randomly-generated preference criteria and the required computational effort is situation- and model-dependent. However, the problem is still solvable to optimality in a reasonable amount of time.

### Example 4

The present invention was tested on a larger panel assignment problem which involves 40 reviewers that must be assigned to 100 proposals, such that each proposal is reviewed exactly 3 times. Thus, N=100, M=40, and K=3. The preference criteria matrix for each reviewer on each proposal is again generated randomly. However, in this problem, each reviewer is given 4 conflicts of interest and gives preferences for 50 proposals from 1 to 50. Then, the other 46 proposals are given a worst-case value of 100. Four different, randomly-generated preference criteria were considered and each was solved with both the original model and the reformulated model to get three integer solutions. The model and solution statistics for this example are shown in FIG. 10. Even though the optimal objective function value and the required computational effort varies between each randomly-generated preference criteria, the problem is still solvable to optimality in a reasonable amount of time.

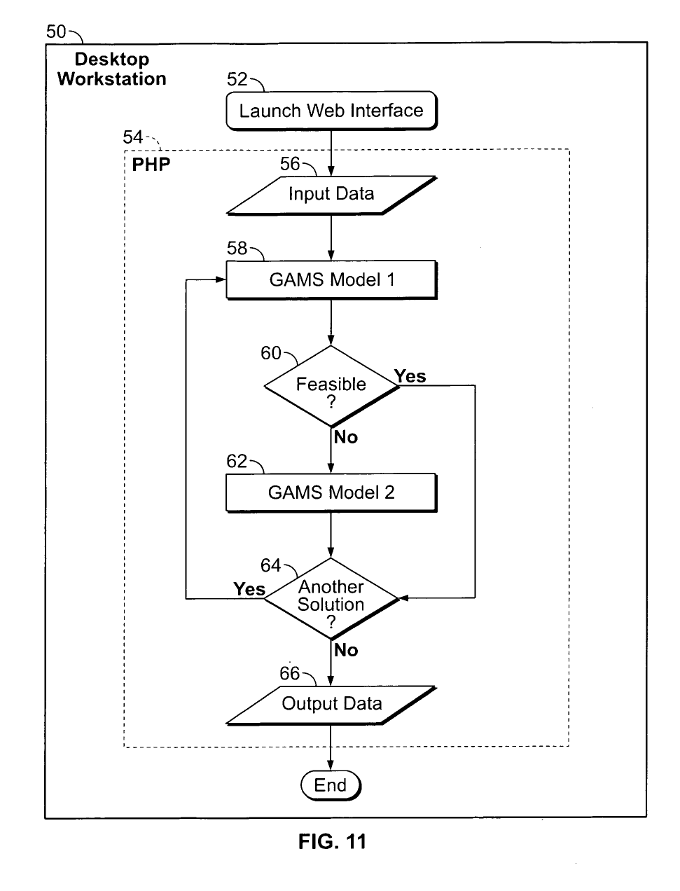

FIG. 11 is a diagram showing software and hardware components, as well as processing logic, for implementing the present invention as a web-based application that can be accessed by any computer system connected to the Internet and running a conventional web browser, such as Microsoft Internet Explorer. A computer 50 is provided, and is connected to the Internet. The computer 50 could include a desktop workstation running a 3.2 GHz Intel microprocessor and the LINUX operating system, or any other suitable operating system. Further, the computer 50 could comprise a server or other type of computing platform. In step 52, the computer 50 launches a web interface application which provides a user on the Internet with a customized web page for accessing the present invention. The web interface could be hosted by any suitable web hosting software, such as the Apache web server running on a LINUX or UNIX operating system, or Microsoft Internet Information Server running on a Microsoft Windows operating system.

When a user accesses the customized web page of the present invention, a hypertext preprocessor (PHP) script 54 is executed. In step 56, the user is presented with a screen for entering information about an assignment problem that the user wishes to solve. The user must enter the number of proposals to consider (N), the number of reviewers to consider (M), the number of reviews needed per proposal (K) where K=3 or K=4, and the number of desired integer solutions. Note that the more integer solutions determined, the longer the total computational time required to generate the desired output. The interface also allows the preference criteria matrix, w_{i,j}, to be entered manually in a provided table, or to be uploaded from a text file or an Excel file, each with a pre-defined format. The interface automatically fills in blank entries in the preference criteria matrix according to the rules set forth herein.

The entered information is stored in an input file generated using the General Algebraic Modeling (GAMS) software package. After the required information has been entered, step 58 is invoked, wherein the problem is solved using the GAMS input file, Model 1 of the present invention, and a linear solver, such as the commercially-available CPLEX linear equation solution software. In step 60, the user determines whether the modeled outcome is feasible. If not, the problem is solved again using the GAMS input file, Model 2 of the present invention, and the CPLEX linear equation solver. While the script 54 is running and the problems are being modeled using Models 1 and 2, the system's progress is reported to the user on a web page. In step 64, a determination is made as to whether another solution must be solved. If so, steps 58-64 are re-invoked as needed. If not, step 66 is invoked, wherein the PHP script 54 processes the results and displays same the user in a web page. An output file is generated that can be downloaded for the user to save or print, and/or it can be e-mailed directly to the user's e-mail address.

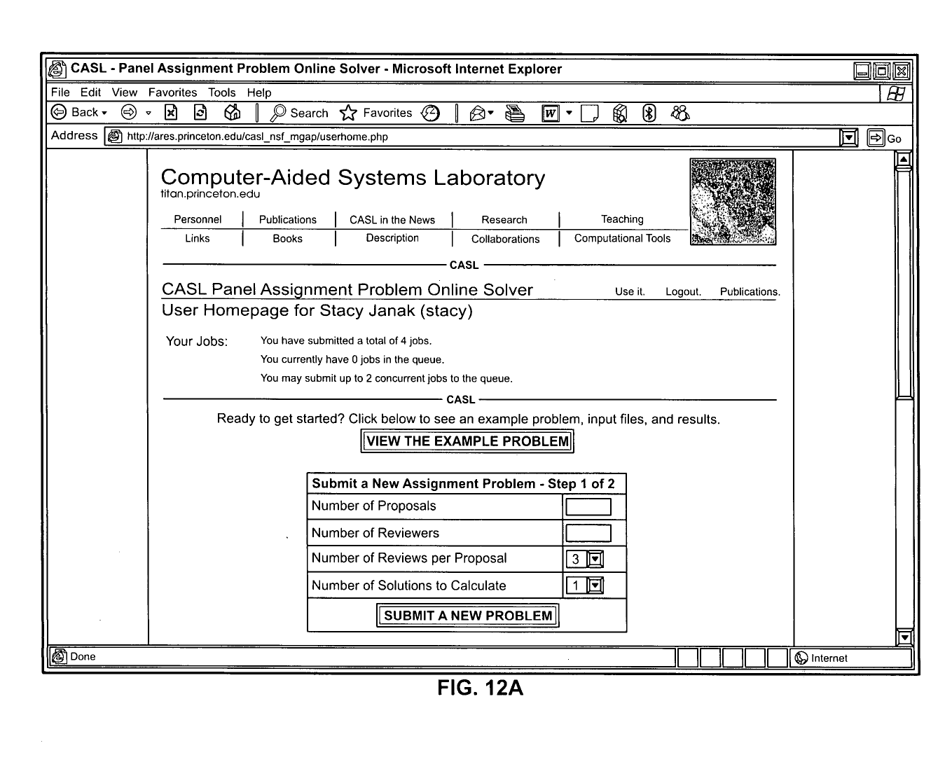

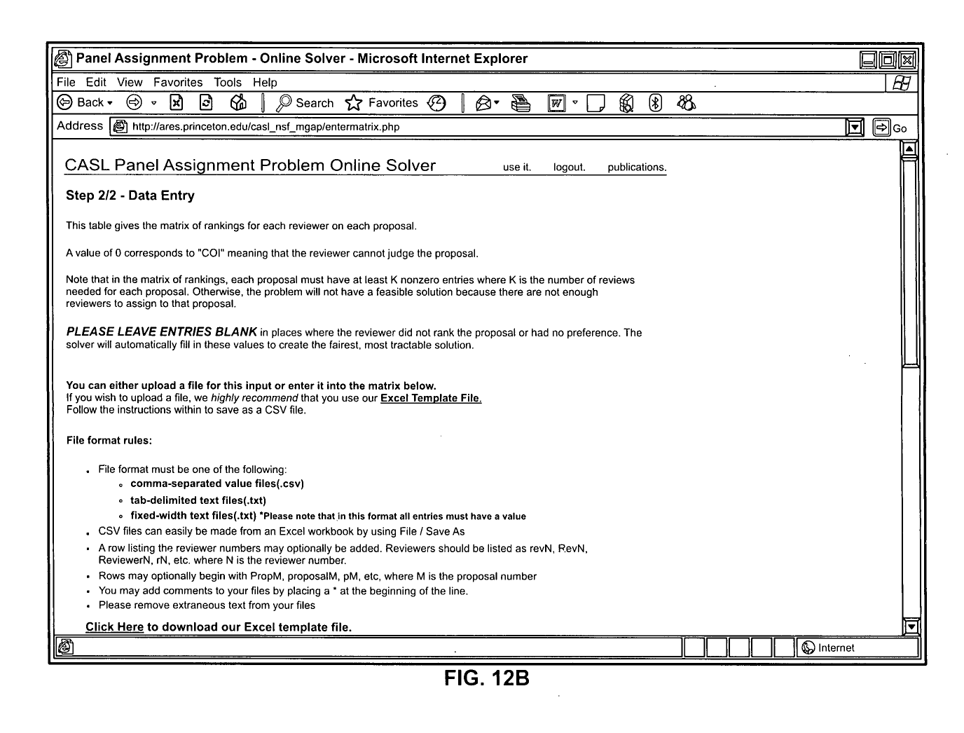

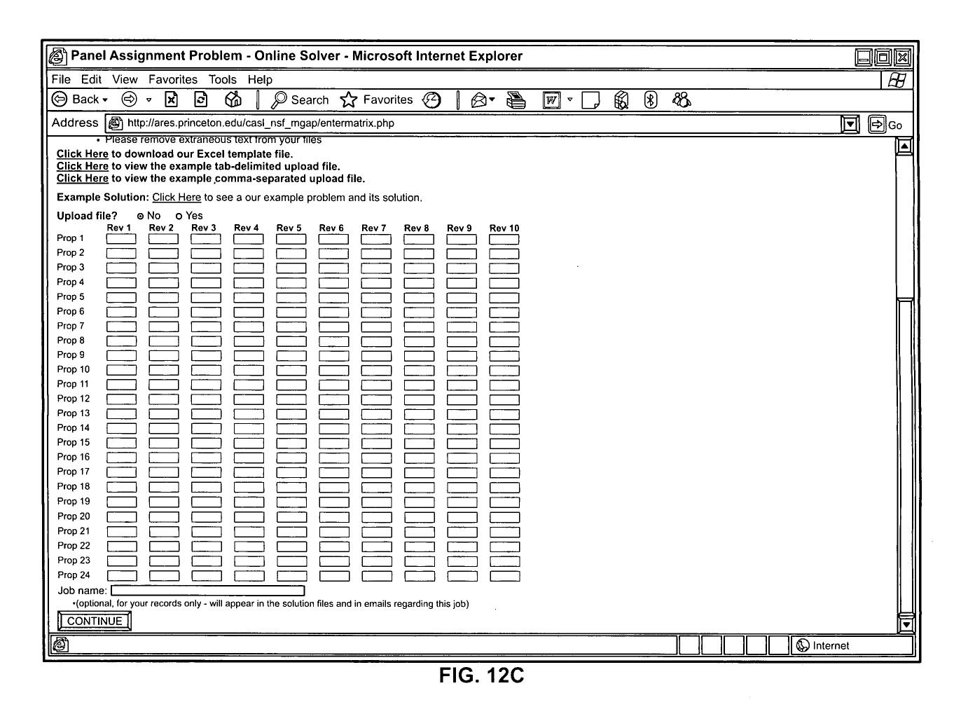

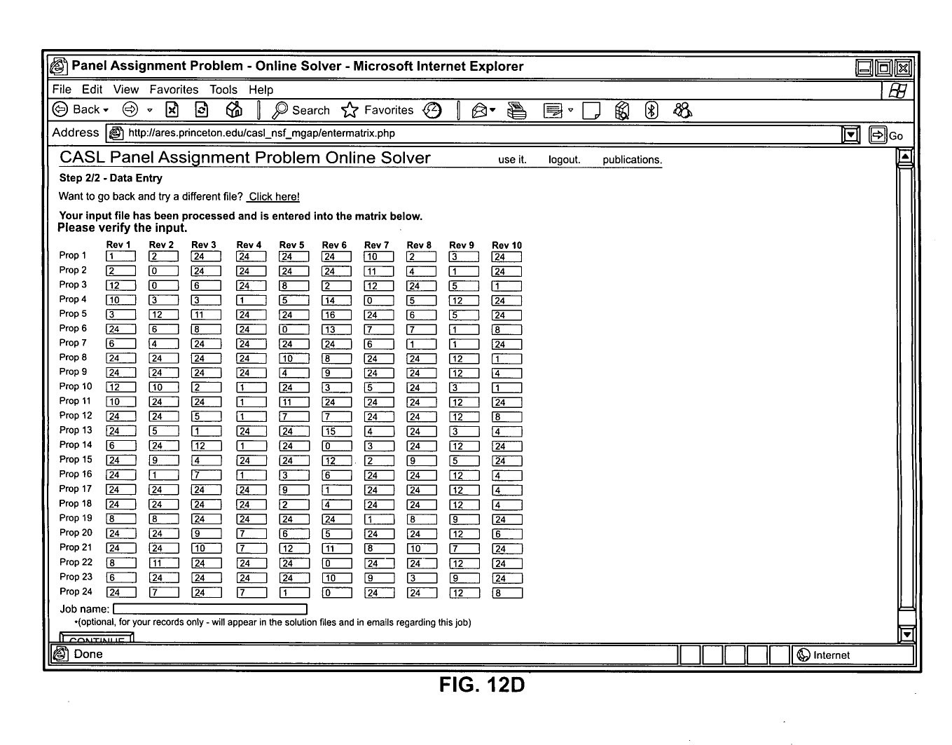

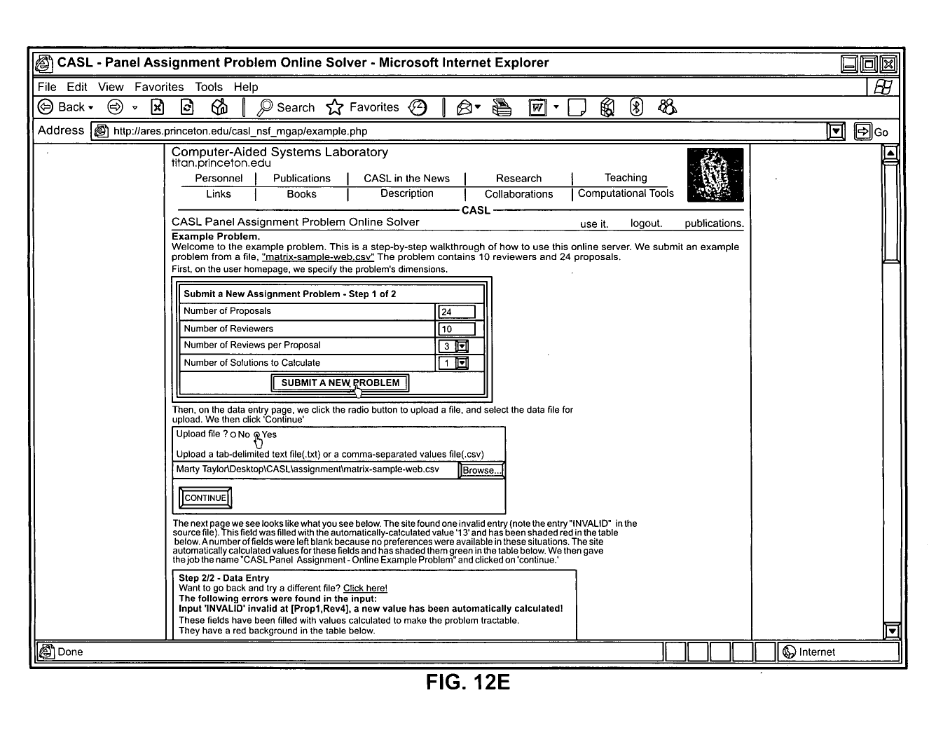

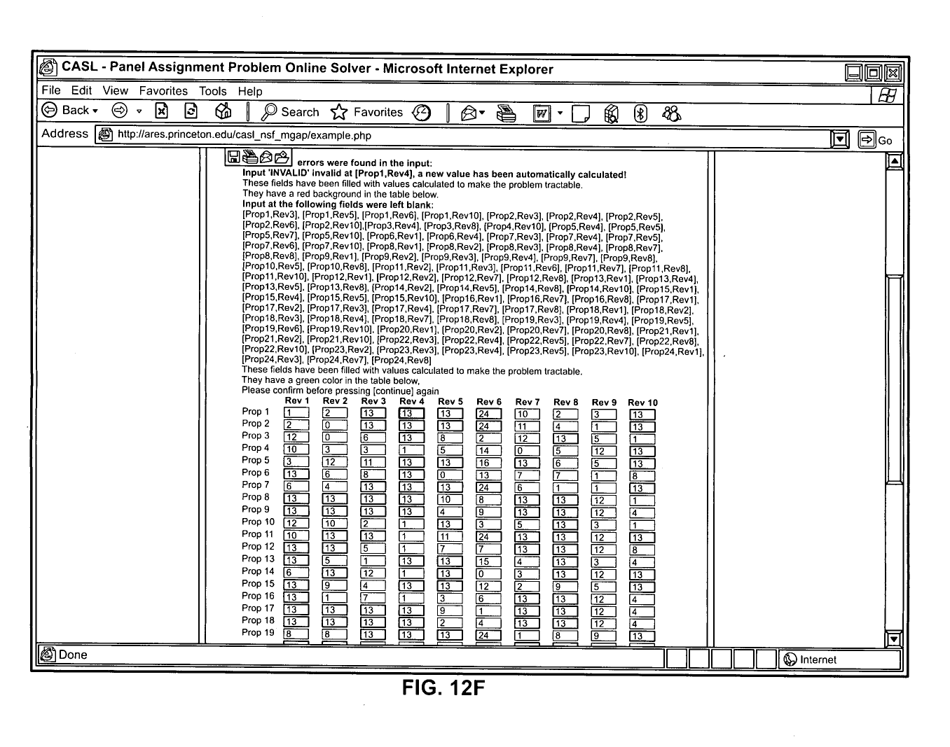

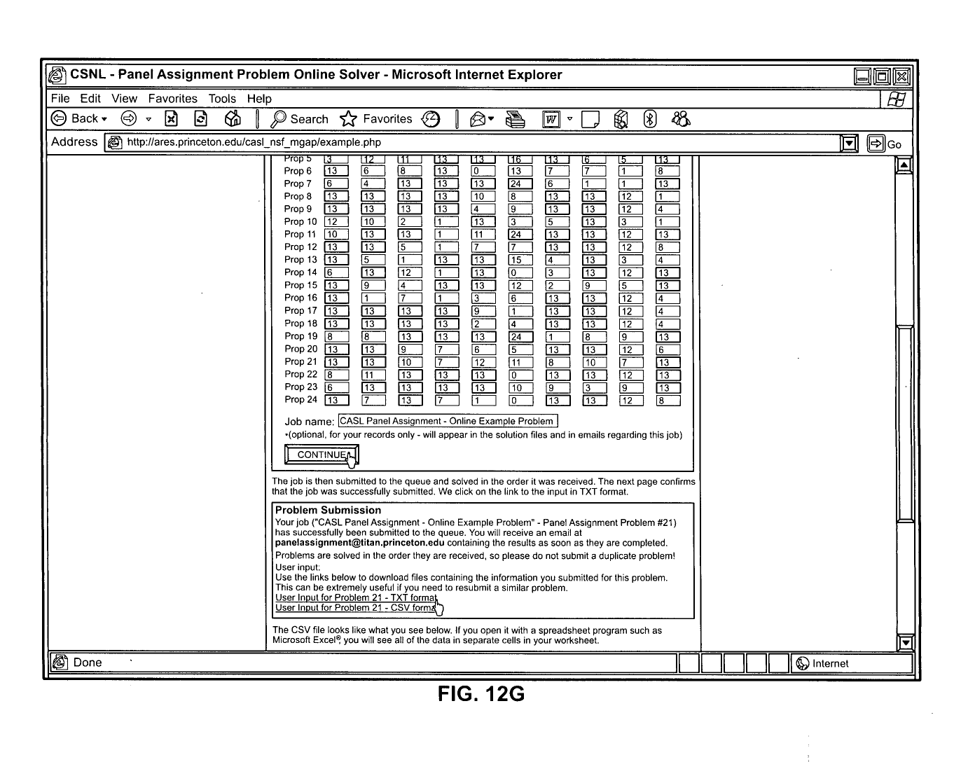

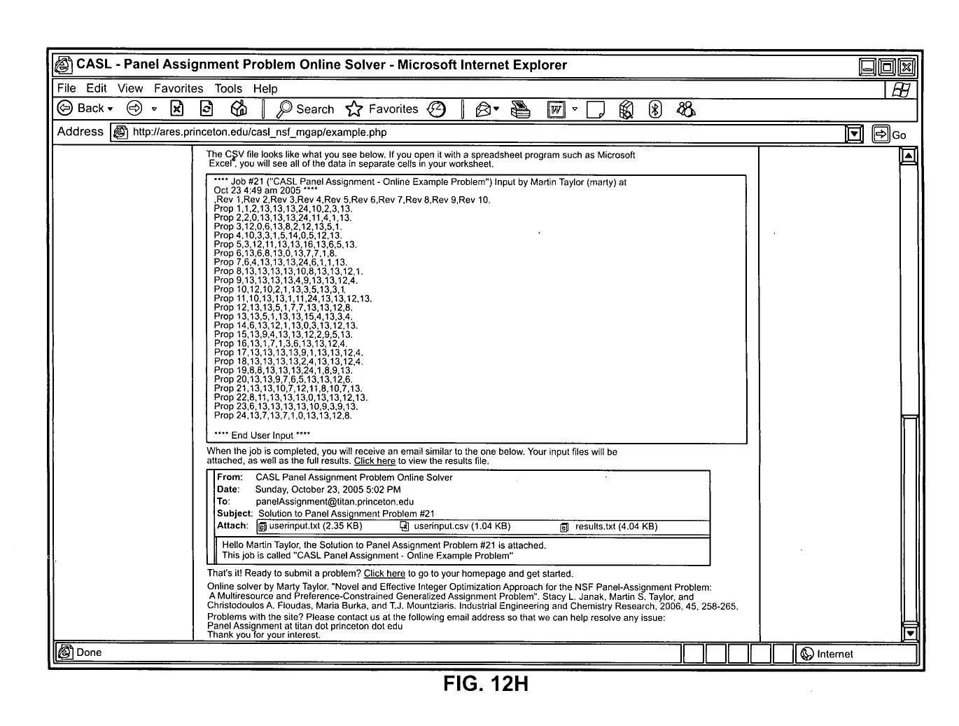

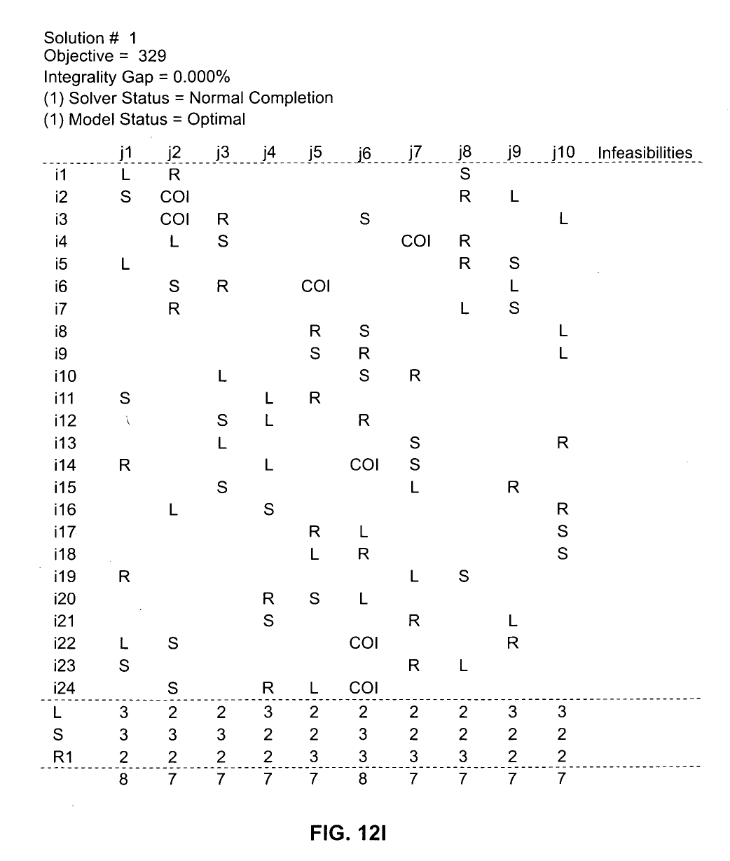

FIGS. 12A-12H are screenshots showing a sample user interface according to the present invention for allowing users to solve panel assignment problems online. As mentioned above, the present invention can be implemented in a customized, web-based application that can be accessed by users on the Internet, using standard web browser software. FIG. 12A is a screenshot showing an initial screen (homepage) for such a system. In this screen, the user can log in and define parameters for a panel assignment problem to be solved. The user could be provided with an example problem by clicking the “View The Example Problem” button on the screen, or a user-defined problem can be entered by supplying the number of proposals, number of reviewers, number of reviews per proposal, and number of solutions to calculate, using the data entry fields at the bottom of the screen. When these parameters have been entered, the user can click the “Submit a New Problem” button to continue.

FIG. 12B-D are screenshots showing the second data entry screen implemented by the present invention. After the foregoing information about the panel assignment problem has been entered by the user, the screen shown in FIGS. 12B-12D is displayed, wherein the user can provide a matrix of rankings (preferences) for each reviewer on each proposal (i.e., the user can define a preference criteria matrix using this screen). A value of 0 can be used to define a conflict of interest (COI). The user can also upload a previously-created matrix of rankings in a suitable file format, such as comma-separated value (CSV) files, tab-delimited text (TXT) files, or fixed-width text files. Also, a sample spreadsheet template (in Microsoft Excel format) is provided to the user, to assist with creating the matrix. As shown in FIGS. 12C-12D, the user can enter the matrix of ranking directly in the screen, in the rows and columns labeled “Prop” (proposal) and “Rev” (reviewer), respectively. After the information has been either directly entered into the screen, or a pre-defined matrix file has been uploaded, the user can then enter an appropriate job name to be assigned to the problem. When the job name has been specified, the problem is submitted to the system of the present invention so that an optimal solution can be generated.

FIG. 12E-H are screenshots showing the aforementioned example problem supplied to the user by the present invention. The example problem provides the user-with a step-by-step tutorial of how to use the system. As shown in FIG. 12E, the user is provided with a tutorial on how to upload a previously-defined matrix of preferences to the system. Importantly, the present invention includes the ability to detect and automatically highlight invalid values in an uploaded matrix file, as shown in FIGS. 12E-12G. Further, for such invalid values, the system can automatically calculate and supply values which make the problem tractable (e.g., solvable within a reasonable time period). Additionally, for fields where no value has been specified, the system also automatically calculates and supplies values which make the problem tractable, and highlights those values. The user can then assign a job name to the problem, and submit it to the system.

As shown in FIGS. 12G-12H, after the problem has been submitted, an e-mail notification is provided to the user with links to text (TXT) and comma-separated value (CSV) files which contain the parameters submitted by the user (including the matrix of rankings). As shown in FIG. 12H, when the optimal solution to the problem is generated by the present invention, the results are e-mailed to the user as TXT and CSV files which can be opened using a variety of popular software applications, such as word processors, spreadsheet applications, and database management systems. Of course, any other suitable file format could be used. An example of an optimal solution e-mailed to a user is shown in FIG. 121. As can be seen, the solution is expressed as a table showing the optimal assignment of lead (L), scribe (S), and reviewer (R) positions, as well as conflicts of interest (COI). The rows represent 24 proposals, and the columns represent a panel of 10 reviewers. Although not shown, any infeasibilities in the solution would be indicated in the column labeled “Infeasibilities.” Tallies of the various reviewer positions are also indicated at the bottom of the table.

As mentioned above, the present invention can be used in a variety of additional applications. For instance, management in a corporation could use the present invention to assign small groups or even individuals to different company projects. Hospitals could use the present invention to assign doctors and nurses to shifts or to patients. Defense agencies could use the present invention to assign combat units to different military tasks. Also, manufacturing facilities could use the present invention to assign operators or maintenance workers to shifts.

Additionally, as mentioned above, the present invention can be implemented to solve specific types of panel assignment problems, such as the NSF panel assignment problem. In such circumstances, new constraints can be defined which allow the user to define pre-assignment rules relating to reviewers and proposals, and existing constraints (such as the constraints defined herein) can be modified to (a) account for the equal treatment of reviewer positions (e.g., by defining a constraint of the type y(i,j)=1, i∈Iⱼ for restricting the assignment of proposal i to reviewer j); (b) allow for customized preference scales for specific types of reviewers (e.g., by implementing an inference logic approach); (c) account for specific reviewer expertise; (d) allow for flexibility in the number of reviewers for different types of proposals; (e) allow for more than 4 reviewers per proposal; and (f) allow for the assignment of multiple reviewers for different sections of a proposal. Moreover, the role of uncertainty of coefficients can be factored into the, models of the present invention through the use of inequality constraints, such as the mixed-integer linear programming inequality constraints represented below in Equations 31-34 and 35.

$$\begin{matrix}{Min / Max}_{x , y , u} {c}^{T} x + {d}^{T} y & Equations 31 –34 \\ s . t . {E}_{x} + {F}_{y} = e & \\ Ax + By \leq p & \\ \underline{x} \geq x \leq \overline{x} & \\ {\sum }_{m} {a}_{l , m} {x}_{m} + {\sum }_{k} {b}_{l , k} {y}_{k} \leq {p}_{l} & Equation 35\end{matrix}$$

To determine the role of uncertainty, Equation 35 is solved for each 1 given changes in the values a_{l,m}, b_{l,k}, and pₗ.

Having thus described the invention in detail, it is to be understood that the foregoing description is not intended to limit the spirit and scope thereof. What is desired to be protected by Letters Patent is set forth in the following claims.

What is claimed is:

1. A method for optimally assigning a plurality of individuals to a plurality of tasks, comprising:
acquiring information about the plurality of individuals and the plurality of tasks;
applying a first modeling algorithm including at least one assignment constraint to the acquired information to produce a first modeled assignment scenario;
determining whether the first modeled assignment scenario is feasible;
if the first modeled assignment scenario is feasible, assigning the plurality of individuals to the plurality of tasks in accordance with the first modeled assignment scenario; and
if the first modeled assignment scenario is not feasible:
applying a second modeling algorithm to the acquired information to produce a second modeled assignment scenario, the second modeling algorithm including a relaxed version of the at least one assignment constraint; and
assigning the plurality of individuals to the plurality of tasks in accordance with the second modeled assignment scenario.

2. The method of claim 1, wherein the step of acquiring information about the plurality of individuals and the plurality of tasks comprises acquiring information about a panel of reviewers.

3. The method of claim 2, wherein the step of acquiring information about the panel of reviewers comprises determining the number of reviewers in the panel.

4. The method of claim 3, wherein the step of acquiring information about the panel of reviewers comprises determining reviewer preferences regarding subject matter.

5. The method of claim 4, wherein the step of acquiring information about the panel of reviewers comprises determining conflicts of interest.

6. The method of claim 2, wherein the step of acquiring information about the plurality of individuals and the plurality of tasks comprises acquiring information about proposals to be reviewed by the panel of reviewers.

7. The method of claim 6, wherein the step of acquiring information about the proposals comprises determining a total number of proposals to be reviewed by the panel of reviewers.

8. The method of claim 6, wherein the at least one assignment constraint comprises a constraint for assigning a reviewer to a proposal based upon reviewer resources.

9. The method of claim 6, wherein the at least one assignment constraint comprises a constraint for assigning a reviewer to a position.

10. The method of claim 6, wherein the at least one assignment constraint comprises a constraint for assigning a reviewer to a proposal based upon reviewer preferences regarding subject matter.

11. The method of claim 1, wherein the step of applying the first modeling algorithm further comprises applying a first modeling algorithm to the acquired information further comprises applying an objective function to the acquired information to minimize potential infeasibilities resulting in a modeled assignment.

12. The method of claim 2, wherein the step of applying the second modeling algorithm further comprises modifying a property of the objective function to produce a feasible assignment.

13. A system for optimally assigning a plurality of individuals to a plurality of tasks, comprising:
a user interface for acquiring information about the plurality of individuals and the plurality of tasks;
means for processing the acquired information using a first modeling algorithm including at least one assignment constraint to produce a first modeled assignment scenario;
means for processing the acquired information using a second modeling algorithm to produce a second modeled assignment scenario, the second modeling algorithm including a relaxed version of the at least one assignment constraint; and
means for displaying the first modeled assignment scenario and the second modeled assignment scenario to a user so that the user can assign the plurality of individuals to the plurality of tasks in accordance with the first or the second modeled assignment scenario.

14. The system of claim 13, wherein the acquired information comprises information about a panel of reviewers.

15. The system of claim 14, wherein the acquired information comprises a total number of reviewers in the panel.

16. The system of claim 15, wherein the acquired information comprises reviewer preferences regarding subject matter.

17. The system of claim 16, wherein the acquired information comprises reviewer conflicts of interest.

18. The system of claim 18, wherein the acquired information comprises information about proposals to be reviewed by the panel of reviewers.

19. The system of claim 18, wherein the acquired information comprises a total number of proposals to be reviewed by the panel of reviewers.

20. The system of claim 18, wherein the at least one assignment constraint comprises a constraint for assigning a reviewer to a proposal based upon reviewer resources.

21. The system of claim 18, wherein the at least one assignment constraint comprises a constraint for assigning a reviewer to a position.

22. The system of claim 18, wherein the at least one assignment constraint comprises a constraint for assigning a reviewer to a proposal based upon reviewer preferences regarding subject matter.

23. The system of claim 13, wherein the first modeling algorithm further comprises an objective function for minimizing potential infeasibilities resulting in a modeled assignment.

24. The system of claim 24, wherein the second modeling algorithm further comprises a modified version of the objective function for producing a feasible assignment.
